(19) United States
(12) Patent Application Publication
(10) Pub. No.: US 2014/0368633 A1
(43) Pub. Date: Dec. 18, 2014

(54) DEVICE FOR VIEWING A DIGITAL IMAGE

(71) Applicants: UNIVERSITE PIERRE ET MARIE CURIE (PARIS 6), Paris (FR); ASSITANCE PULBIQUE-HOPITAUX DE PARIS, Paris (FR)

(72) Inventors: Gilles Le Naour, Bry sur Marne (FR); Francois De Trazegnies D'Ittre, Villejuif (FR); Frédérique Capron, Paris (FR)

(73) Assignees: ASSISTANCE PUBLIQUE - HOPITAUX DE PARIS, Paris (FR); UNIVERSITE PIERRE ET MARIE CURIE (PARIS 6), Paris (FR)

(21) Appl. No.: 14/356,050

(22) PCT Filed: Nov. 5, 2012
(86) PCT No.: PCT/EP2012/071860

§ 371 Date: Sep. 2, 2014

(30) Foreign Application Priority Data
Nov. 4, 2011 (FR) 11 60001

(51) Int. Cl. G02B 21/36

(52) U.S. Cl. CPC G02B 21/365
USPC 348/80

(57) ABSTRACT

The invention relates to a device for viewing a digital image comprising means (2) for viewing at least one portion of the digital image. According to the invention, the viewing means include a viewing mask (2) held by a stand (3) such that the viewing mask (2) is used at the eye level of a user such that same can bring his/her eyes closer to the viewing mask in order to examine the portion of the digital image displayed, the viewing mask comprising side extensions (6g, 6d) for protecting the user from outer visual interferences, and in that the viewing device further includes at least one movement handling device (7, 200) that can be controlled by the user in order to control virtual movement of the digital image such that the user is able to view another portion of the digital image.

The invention relates to a device for viewing a digital image, and notably for viewing a virtual slide for the purpose of helping a user to analyze and study this digital image.

### TECHNICAL BACKGROUND OF THE INVENTION

Histology is a medical and biological science concerned with the study of the structure of human, animal or plant tissues. Normally, a sample of the tissue to be studied is taken, treated by physical-chemical methods, and then cut with a microtome to provide a section with a thickness of about two micrometers, which is placed on a glass slide. The constituents specific to the tissue are detected in this section, using dyes or immunological markers. Finally, said section is covered with a second glass slide. The assembly then forms a physical glass slide, called a “real slide”, which is then conventionally observed with an optical microscope.

For several years, it has also been possible to scan a real slide with a dedicated slide scanner. The real slide is then digitized at a very high resolution in the form of a very high definition computer image file. This image file is currently called a “virtual slide”.

This virtual slide can therefore be observed directly on a computer screen, and a user can create a virtual movement of the virtual slide and also zoom in on a desired portion of the virtual slide. A virtual slide can be used to carry out a study that is as precise as an optical microscope study of the corresponding real slide.

Virtual slides have numerous advantages over real slides, notably in a medical and scientific context.

This is because, if a doctor observes a real slide and is unable to reach a diagnosis of a possible pathology, he must send another slide, created from the tissue under study, to an expert colleague by post, so that said colleague can then study the real slide. Since this real slide is very fragile, it may become damaged in transit, making it impossible to study. Furthermore, the new real slide does not incorporate the same section as the initial slide, and therefore the expert colleague does not study the same section as the doctor who has requested the expert examination. Similarly, if the doctor has to create a new slide from the tissue under study for a compulsory medical re-examination, the new slide will not be identical to the first one. The difference between the two slides may introduce a difference or an error into the diagnosis and prognosis.

The distinctive feature of the virtual slide is that it is unique and can be stored on a data medium. The virtual slide can therefore be placed on-line on a server, making it very easy to access. A doctor can therefore study the virtual slide remotely, while other doctors can observe the same virtual slide at the same time, even if they are located at sites which are widely separated geographically.

Furthermore, the virtual slide is an image file and therefore remains unchanged over time.

Because of the ease and speed of access to virtual slides via a server, an image bank or the like, these slides greatly facilitate the development of a diagnosis and prognosis of a disease in a tissue under study.

The use and examination of virtual slides are therefore applicable to the study of all biological human and animal tissues, as well as to the study of plant tissues . . . The use of virtual slides is particularly useful for telemedicine, and notably for telepathology, which requires the study of a histological tissue and therefore the very accurate transmission of the texture and color of said tissue. Telepathology is a specialized field of telemedicine which consists in the remote performance of anatomopathological studies on virtual slides, between two or more centers which are spaced apart. The aim is to produce a diagnosis or to obtain a second medical opinion. In addition to remote diagnosis, telepathology also makes use of virtual slides for teaching, remote training and scientific research.

However, the doctor observes the virtual slide on a computer screen. It has been found that the display of a virtual slide on a screen of this type, regardless of its size and resolution, does not allow the doctor to concentrate easily for the purpose of carrying out an anatomopathological study.

### OBJECT OF THE INVENTION

One aim of the invention is to propose a device for viewing a digital image, such as a virtual slide, which enables a user to concentrate easily on the study of said digital image.

### BRIEF DESCRIPTION OF THE INVENTION

In order to achieve this aim, a viewing device for viewing a digital image, for example a virtual slide, is proposed, this device including viewing means for viewing at least one part of the digital image.

According to the invention, the viewing means comprise a viewing mask held by a support in such a way that the viewing mask is in operation at the level of the observer's eyes, so that the observer can move his eyes toward the viewing mask to examine the part of the digital image being viewed, the support having a proximal end forming a base intended to be placed on a table and a distal end shaped to hold the viewing mask, the viewing mask having lateral extensions to isolate the user from external visual disturbances, the viewing device further comprising at least one movement control member, operable by the user to cause a virtual movement of the digital image so that the user can view another part of the digital image.

The user therefore observes the digital image solely through the viewing mask, thereby reducing his field of view and facilitating his concentration.

Thus the user analyzes a virtual slide more efficiently and more rapidly than when viewing said virtual slide on a computer screen.

The inventors have found that the act of moving the eyes very close to the viewing mask facilitates the user's concentration as a result of the visual elimination of all light pollution, to such an extent that even some external audible disturbances become less disturbing.

Moreover, the inventors have also found that the viewing device according to the invention is very ergonomic for a doctor, since the viewing device resembles an optical microscope in that the virtual slide is viewed solely through the dedicated viewing mask, which is similar to the eyepieces of an optical microscope, and also to the means for moving the virtual slide which are manually operated, as on an optical microscope.

### BRIEF DESCRIPTION OF THE DRAWINGS

The invention will be made clearer by the following description of a specific non-limiting embodiment of the invention, given with reference to the attached figures, in which:

FIG. 1 is a schematic perspective view of a viewing device according to a first embodiment of the invention;

FIG. 2 is a schematic perspective view of a viewing device according to a second embodiment of the invention.

### DETAILED DESCRIPTION OF THE INVENTION

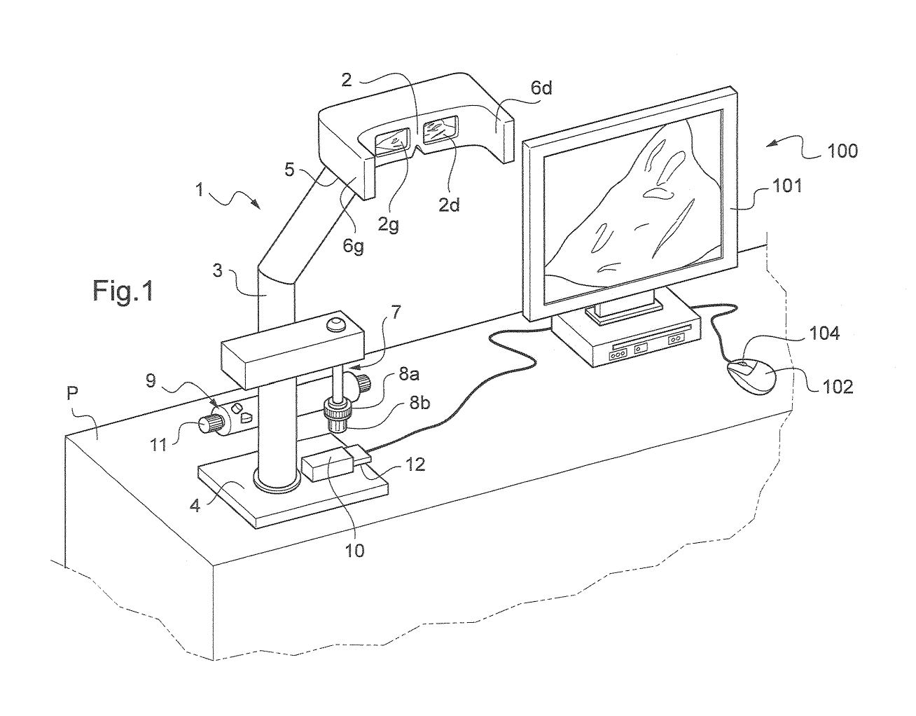

With reference to FIG. 1, the viewing device 1 according to the invention is, in this case, placed on a desk P. In this case, the viewing device 1 allows the viewing of a virtual slide where the user works in human or animal biology, plant biology or any other field in which microscopy, and therefore the study of virtual slides, is used.

The viewing device 1 includes means for viewing at least one part of a virtual slide.

Thus the viewing means include a viewing mask 2. The viewing device 1 further includes a support 3, a proximal end of which forms a base 4 resting on the desk P. A distal end 5 of the support 3 is shaped to hold the viewing mask 2 so that the viewing mask 2 is at the level of a user's eyes when, in operation, the user moves his eyes toward the viewing mask 2.

In this case, the support 3 includes a control unit 10 comprising a connection port 12. The viewing device 1 includes, in this case, a computer 100 near which the support 3 is placed, the control unit 10 being connected to the computer 100 by means of its connection port 12. Thus, by means of the computer 100, a user can retrieve a virtual slide to be studied from a server, a database or the like, the user being able to study said virtual slide through the viewing mask 2. Advantageously, the user may also view at least one part of the virtual slide on a screen 101 of the computer 100.

In this case, the viewing mask 2 includes two digital screens 2d, 2g on which the virtual slide can be viewed. According to the invention, when a user moves his eyes toward the viewing mask 2, each eye being associated with one of the digital screens 2d, 2g, he can view a portion of the virtual slide. Thus the user observes the virtual slide solely through the viewing mask 2, thereby reducing his field of view.

The viewing mask 2 is configured to isolate the user as far as possible from external visual disturbances. For this purpose, the viewing mask 2 includes lateral extensions 6g, 6d shaped so that, when the user moves his eyes toward the viewing mask 2, the branches 6g, 6d extend along each side of the user's face. Thus the branches 6g, 6d further reduce an external field of view of the user, thereby facilitating the user's concentration.

When the user moves his eyes toward the viewing mask 2 to examine the viewed part of the virtual slide, he is thus isolated from external visual disturbances. It is therefore easier for the user to concentrate on the viewing of the virtual slide, and therefore on the study and analysis of said virtual slide, whereas, if he merely viewed the screen 101 of the computer 100, the user might be troubled by reflections of the screen 101 of the computer 100, by an environment of the screen 101, or by other factors.

The viewing mask is, for example, a mask of the head mounted display type.

According to the invention, the viewing device 1 includes a first movement control member 7 operable by the user to cause a virtual movement of the virtual slide in such a way that the user can view another part of the virtual slide. According to a preferred embodiment, the first movement control member 7 can be operated in such a way that the whole of the virtual slide can be viewed by the user in successive viewings of parts of the virtual slide.

In this case, the first movement control member 7 is placed on the support 3 and includes a first thumbwheel 8a and a second thumbwheel 8b, the two thumbwheels 8a, 8b being coaxial and operable, respectively, to cause a virtual movement of the virtual slide in two different directions. Preferably, the thumbwheels 8a, 8b of the first movement control member 7 are connected to the control unit 10 in such a way that when the user rotates the first thumbwheel 8a the part of the virtual slide viewed is moved proportionally in a horizontal direction, and when the user rotates the second thumbwheel 8b the part of the virtual slide viewed is moved proportionally in a vertical direction.

The first movement control member 7 is preferably arranged on the support 3 in such a way that the two thumbwheels 8a, 8b are oriented on one or other side of the support 3 according to whether the regular user of the viewing device 1 is right- or left-handed.

According to a preferred embodiment, the viewing device 1 includes a second movement control member operable by the user to cause a virtual movement of the virtual slide in such a way that the user can view another part of the virtual slide. In this case, the second movement control member comprises a mouse 102 connected to the computer 100. The user can thus act simultaneously on the part of the virtual slide that he observes on the screen 101 and on the part of the virtual slide that he observes through the viewing mask 2, a movement of the mouse 102 resulting in a proportional movement of the virtual slide.

Preferably, the viewing device 1 further includes a first zoom control member 9 operable by the user to cause a virtual zoom of the virtual slide, in such a way that the user can obtain a more detailed view of a portion of the part of the virtual slide being viewed. In this case, the zoom control member 9 is arranged on the support 3 and includes a knurled thumbwheel 11 which is connected to the control unit 10 in such a way that, when the user rotates the knurled thumbwheel 11, this causes a proportional enlargement of a portion of the part of the virtual slide being viewed.

Preferably, when the zoom control member 9 is in its minimum position, the whole virtual slide can be observed through the viewing mask 2.

According to a preferred embodiment, the viewing device 1 includes a second zoom control member operable by the user to create a virtual zoom of the virtual slide, in such a way that the user can obtain a more detailed view of a portion of the part of the virtual slide being viewed. In this case, the second zoom control member comprises a scrolling wheel 104 mounted on the mouse 102. The user can thus act simultaneously on the part of the virtual slide that he observes on the screen 101 and on the part of the virtual slide that he observes through the viewing mask 2, a movement of the scrolling wheel 104 of the mouse 102 resulting in a proportional enlargement of the virtual slide.

A user can thus use the viewing device 1 in a highly intuitive manner. In this case, he can also choose which movement control member 7, 102 and which zoom control member 9, 104 is to be used for the purpose of acting on the virtual slide.

Preferably, the assembly formed principally by the support 3 and the viewing mask 2 is shaped so as to have the general shape of an optical microscope. Thus the support 3 is shaped, in this case, so as to have the general shape of an optical microscope stand.

According to a preferred embodiment, the two thumbwheels 8a, 8b of the first movement control member 7 are positioned on the support 3 so as to be substantially positioned in the same way as a movement control member of a carrier of a standard optical microscope. It will be recalled that a control member for an optical microscope of this type has two coaxial thumbwheels, one thumbwheel causing the carrier to move in a horizontal direction and the other causing the carrier to move in a vertical direction.

Preferably, the knurled thumbwheel 11 of the first zoom control member 9 is positioned on the support 3 so as to be substantially positioned in the same way as a focusing screw of a standard optical microscope, for example a macrometric or micrometric screw.

Thus, because of the appropriate shape of the support 3, the first movement control member 7 and the first zoom control member 9 make the use of the viewing device 1 even more intuitive for a user. Advantageously, the user can thus easily change from the observation of a real slide according to the prior art on an optical microscope to the observation of a virtual slide on the viewing device 1.

Furthermore, the viewing device 1 according to the invention has certain advantages over an optical microscope. For example, the viewing mask 2 provides much greater comfort than the eyepieces of an optical microscope, while also providing the function of reducing the user's field of view in the same way as the eyepieces of an optical microscope.

The viewing device according to the invention may also be described as a digital microscope, since said device returns an entirely digital image obtained from a data medium such as a computer, thus enabling a digital image to be viewed. This does not in any way resemble a conventional optical microscope, which has to be connected to a camera or to a photographic device to enable the images taken by said camera or device to be studied in real time. The device according to the invention includes neither a camera nor a photographic device, and is simply connected by a wire or wireless link to a data medium containing digital images.

Evidently, the invention is not limited to the embodiment that has been described, and variant embodiments thereof may be devised without departing from the scope of the invention as defined by the claims.

In particular, although in this case the device according to the invention allows the viewing of a virtual slide, the device according to the invention may be used for viewing other digital images, notably those of a scientific and/or medical nature.

In particular, although in this case the support 3 is connected to the computer 100 which has a screen 101 on which the digital image can also be viewed, the support 3 may be placed in a quite different environment. For example, the support 3 may be connected to a computer 100 without being placed directly in the proximity of the screen 101 of the computer 100. However, it is advantageous to keep the support 3 and said screen 101 near to each other. This is because the user then has access to two means for viewing the digital image to be studied.

It is possible for the viewing device 1 not to include a computer screen 101. The support will then be simply connected to a computer connected to a network on which digital images are available. The support may be linked by a wire or wireless means to a computer, a computer network, a touch screen tablet, a telephone of the Smartphone type, a USB flash drive or any other data medium. If the support includes wireless communication means such as Wi-Fi or Bluetooth, it is then more compact and more independent. The viewing device is then more easily transportable from one point to another. The support may also be connected to a device (such as a touch screen tablet or a telephone of the Smartphone type) which is itself provided with means for wireless communication with a computer network.

Although the control unit 10 in this case has a single connection port, the control unit 10 may have a larger number of connection ports, for example in order to connect the control unit simultaneously to a computer 100 and to a USB flash drive.

The viewing device according to the invention may include storage means, for example in order to allow:
the recording of a particular user-selected area of the digital image;
the recording of notes taped or dictated by the user, in order to link them to the digital image studied by the user.

The storage means may, for example, be carried by the support. The viewing device may include voice recording means (a microphone linked to a voice recognition system, for example) for the purpose of recording the notes dictated by the user, or may comprise a keyboard for recording the notes typed by the user. Advantageously, where voice recognition means are provided, the user may simply concentrate on the viewing of the digital image, without looking away in order to create his notes.

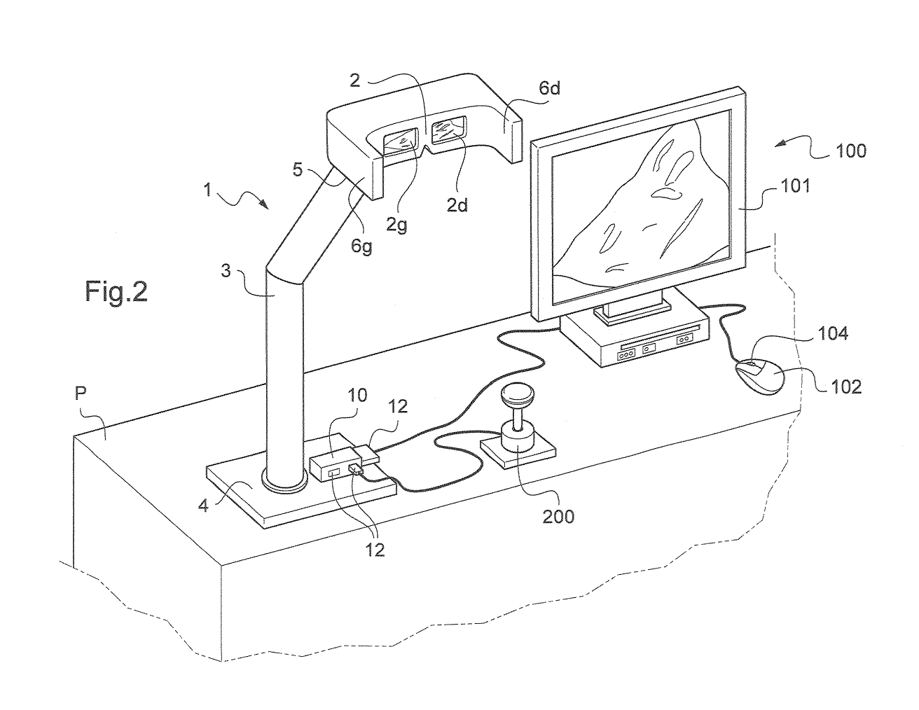

Additionally, the viewing device 1 may include a different number of control members from that illustrated, and different control members from those illustrated, provided that the viewing device 1 includes at least one movement control member operable by the user to cause a virtual movement of the digital image. With reference to FIG. 2, in a preferred embodiment, the viewing device 1 includes a movement control member operable by the user to cause a virtual movement of the digital image in such a way that the user can view another part of the digital image, said member including a joystick 200. The joystick 200 is, for example, connected to the processing member 10 by a wire link, using one of the connection ports 12 of the viewing device 1. In a variant, of a viewing device 1 according to the first embodiment, the user also connects a joystick 200 to the control unit 10. The user can thus choose which movement control member he prefers to use in order to cause a virtual movement of the digital image.

In a variant, the movement member or one of the movement members may be a touch screen, such as a touch screen tablet or a telephone of the Smartphone type: the digital image can thus be moved and/or enlarged virtually directly from said touch screen.

However, it will be preferable to use an operating device 1 in which at least one control member is mounted directly on the support 3 of the viewing device 1, thereby making the viewing device 1 much more compact and closer to the shape of an optical microscope.

Although the viewing device 1 in this case includes a movement control member for virtually moving the digital image and a zoom control member for virtually creating enlargements of the digital image, it would be feasible for the control members to allow other virtual operations to be performed on the digital image. For example, if a real slide is scanned on a plurality of focal planes, the viewing device 1 may include a focal plane control member operable by the user to cause a virtual movement of the associated digital image from one focal plane to another.

It is possible for only a part of the digital image to be viewable by means of the viewing device 1.

The viewing device 1 may be made in a form other than that illustrated. For example, although in this case the support 3 of the viewing mask 2 is non-deformable, the support 3 may be configured so that a user can adapt the height of the support 3 in order to place the viewing mask 2 at a height which is satisfactory for him. The support 3 may, for example, be configured as a deformable arm. In all cases, the support will include a proximal end forming a base intended to be set down and a distal end configured to hold the viewing mask in such a way that the user does not have to carry the viewing device. The viewing device according to the invention is thus totally independent of a user.

Although in this case the support 3 serves simply to hold the viewing mask 2, the support 3 may also contribute the isolation of the user from external visual disturbances, by framing the viewing mask 2, for example so as to surround the user's forehead when the user is viewing the digital image through the viewing mask 2, with the advantage that the user is made completely independent.

1. A viewing device for viewing a digital image, including viewing means for viewing at least one part of the digital image, characterized in that the viewing means comprise a viewing mask held by a support in such a way that the viewing mask is in operation at the level of the observer's eyes, so that the observer can move his eyes toward the viewing mask to examine the part of the digital image being viewed, the support having a proximal end forming a base intended to be set down on a table and a distal end configured to hold the viewing mask, the viewing mask having lateral extensions to isolate the user from external visual disturbances, and in that the viewing mask further comprises at least one movement control member operable by the user to cause a virtual movement of the digital image so that the user can view another part of the digital image.

2. The viewing device as claimed in claim 1, wherein the viewing mask is a head mounted display mask.

3. The viewing device as claimed in claim 1, wherein the movement control member includes two coaxial thumbwheels which can be operated, respectively, to cause a virtual movement of the digital image in two different directions.

4. The viewing device as claimed in claim 1, wherein the movement control member comprises a joystick.

5. The viewing device as claimed in claim 1, wherein the movement control member comprises a mouse.

6. The viewing device as claimed in claim 1, wherein the movement control member comprises a touch screen.

7. The viewing device as claimed in claim 1, further comprising at least one zoom control member operable by the user to produce a virtual zoom of the digital image.

8. The viewing device as claimed in claim 7, wherein the zoom control member comprises a knurled thumbwheel.

9. The viewing device as claimed in claim 1, wherein the support is configured so as to take the general form of an optical microscope stand.

10. The viewing device as claimed in claim 3, wherein the two thumbwheels of the movement control member are positioned on the support so as to be substantially positioned in the same way as a movement control member of a carrier of an optical microscope.

11. The viewing device as claimed in claim 8, wherein the knurled thumbwheel of the zoom control member is positioned on the support so as to be substantially positioned in the same way as a focusing screw of an optical microscope.
